(19) United States
(12) Patent Application Publication
(10) Pub. No.: US 2019/0080613 A1
(43) Pub. Date: Mar. 14, 2019

(54) METHOD FOR OPERATING A VEHICLE

(71) Applicant: Robert Bosch GmbH, Stuttgart (DE)

(72) Inventor: Hanno Homann, Hannover (DE)

(21) Appl. No.: 16/123,510

(22) Filed: Sep. 6, 2018

(30) Foreign Application Priority Data
Sep. 8, 2017 (DE) 102017215844.1

(51) Int. Cl. G08G 1/16; G06K 9/00; B60W 30/12; B60W 30/14

(52) U.S. Cl. CPC G08G 1/167; G06K 9/00798; G06K 9/00805; B60W 2540/18; B60W 30/143; B60W 2520/10; B60W 30/12

(57) ABSTRACT

A method is described for operating a vehicle having the steps: reading in at least one adjustable vehicle parameter and at least one fixed vehicle parameter; reading in vehicle-camera data; detecting at least one object in an environment of the vehicle on the basis of the read-in vehicle-camera data. The method includes the additional steps: ascertaining at least two vehicle-setpoint trajectories, at least one adjustable vehicle parameter and at least one fixed vehicle parameter of the vehicle being taken into account in each case; assessing the at least two ascertained vehicle-setpoint trajectories as a function of the at least one detected object; selecting a vehicle-setpoint trajectory as a function of the assessment; controlling at least one adjustable vehicle parameter as a function of the selected vehicle-setpoint trajectory.

### FIELD OF THE INVENTION

The present invention relates to a method for operating a vehicle, to a computer program product having program code for executing the method, and to a device for operating a vehicle.

### BACKGROUND INFORMATION

The detection of a suitable driving corridor or a suitable driving trajectory is an important prerequisite both for driver-assistance systems and for automatically driving vehicles. A method for providing a driving corridor for a vehicle is known from the document German Published Patent Application No. 102013201796 A1. A driving corridor having a speed-dependent restriction is ascertained on the basis of environment-detection data. Using the driving corridor having the speed-dependent restriction, a driving corridor having a speed-independent restriction is ascertained for the vehicle.

### SUMMARY

The present invention is based on a method for operating a vehicle. The method includes the following steps: Reading in at least one adjustable vehicle parameter and at least one fixed vehicle parameter; reading in vehicle-camera data; and detecting at least one object in an environment of the vehicle based on the read-in vehicle-camera data.

According to the present invention, the method includes the following additional steps: Ascertaining at least two vehicle-setpoint trajectories for which at least one adjustable vehicle parameter and at least one fixed vehicle parameter of the vehicle are taken into account in each case; assessing the at least two ascertained vehicle-setpoint trajectories as a function of the at least one detected object; selecting a vehicle-setpoint trajectory as a function of the assessment; and controlling at least one adjustable vehicle parameter as a function of the selected vehicle-setpoint trajectory.

An adjustable vehicle parameter may be understood as a parameter of the vehicle that is able to be adjusted. For example, an adjustable vehicle parameter could be the speed, the steering angle and/or the steering-wheel torque of the vehicle.

A fixed vehicle parameter may be understood as a parameter of the vehicle that is fixed. A fixed vehicle parameter is unable to be adjusted. For example, a fixed vehicle parameter may be the wheel base, the length, the width, the maximum speed, the maximum acceleration, and/or the maximum steering angle of the vehicle.

Vehicle-camera data may be understood as data that have been recorded with the aid of a vehicle camera. The vehicle-camera data may be read in with the aid of a read-in means of vehicle-camera data, for instance.

An object in an environment of the vehicle may be a static object. A static object can be a lane demarcation. A lane demarcation could be a lane marking, a curbstone, a border around a free space, a downward sloping road edge and/or a row of parked vehicles. A static object may be part of the vegetation in the environment of the vehicle, a parked vehicle and/or a building in the environment of the vehicle. An object in an environment of the vehicle can be a dynamic object. A dynamic object may be a moving vehicle and/or a further road user, in particular a pedestrian.

A kinematic vehicle model is able to be utilized when ascertaining at least two vehicle-setpoint trajectories. Especially the considered fixed vehicle parameters become part of the kinematic vehicle model. Each one of the at least two vehicle-setpoint trajectories is able to be ascertained with the aid of a non-holonomic vehicle model.

Using methods known to one skilled in the art, a vehicle setpoint corridor is able to be ascertained for each of the ascertained at least two vehicle-setpoint trajectories. In this context, the vehicle corridor associated with a vehicle trajectory may be defined as the region that is traversed by the vehicle when it drives along the vehicle trajectory.

The advantage of the present invention is that the method is able to be executed when only a vehicle camera is provided. No further sensors are necessary for detecting the environment of the vehicle. Different objects in the environment of the vehicle are able to be taken into account. Especially advantageous in this context is the consideration of both marked and unmarked lane demarcations. In addition, a better selection of precisely one vehicle-setpoint trajectory is possible on account of the ascertainment and assessment of at least two vehicle-setpoint trajectories. Collisions with static and/or dynamic objects in the environment of the vehicle are able to be avoided with the aid of the selected vehicle-setpoint trajectory.

In a specific development of the present invention, it is provided that the adjustable vehicle parameter of the vehicle that is taken into account when ascertaining the at least two vehicle-setpoint trajectories is the adjustable steering angle of the vehicle.

The advantage of this specific embodiment is that in particular actually realizable steering angles of the vehicle are able to be taken into account when ascertaining the at least two vehicle-setpoint trajectories.

In a further specific embodiment of the present invention, it is provided that for the ascertainment of each of the at least two vehicle-setpoint trajectories, the adjustable steering angle of the vehicle is calculated with the aid of a B-spline as a function of time.

If the speed of the vehicle as a function of time is known, then the vehicle-setpoint trajectories may alternatively also be interpreted as functions of a traveled driving distance.

A B spline is a basis spline. A B spline is a mathematical function that is composed of polynomials in a piecewise manner. The locations in which two polynomials abut are called control points (or also De Boor points). Using the De Boor algorithm, it is possible to calculate what is known as basis functions.

The adjustable steering angle of the vehicle may be an adjustable vehicle parameter that is meant to be optimized. The adjustable steering angle δ(t) of the vehicle as a function of time t is able to be calculated using the basis functions (Bᵢ(t):

$$δ ( t ) = {\sum }_{i = 0}^{n - 1} {δ}_{i} \cdot {B}_{i} ( t )$$

δᵢ being the parameters to be optimized, where i=(O, . . . , n−1). The instantaneous actual steering angle of the vehicle may be used as initial condition δ₀. Parameters δᵢ are appropriately selected for each vehicle-setpoint trajectory. Given predefined parameters δ₁, the adjustable steering angle of the vehicle as a function of time is able to be calculated with the aid of the basis functions defined in advance.

The calculated adjustable steering angle of the vehicle as a function of time may be utilized when ascertaining at least two vehicle-setpoint trajectories. Each of the at least two vehicle-setpoint trajectories may be ascertained with the aid of a non-holonomic vehicle model. Using the non-holonomic vehicle model and on the basis of the calculated adjusted steering angle of the vehicle as a function of time and on the basis of an adjustable speed as a function of time, the x and y positions and the orientations along the at least two vehicle-setpoint trajectories are able to be ascertained in an x,y coordinate system.

The advantage of this specific embodiment is that the ascertainment of each of the at least two vehicle-setpoint trajectories requires fewer data for the adjustable vehicle parameter of the vehicle than other methods for ascertaining vehicle trajectories. When ascertaining each of the at least two vehicle-setpoint trajectories, fewer data have to be ascertained for the adjustable steering angle of the vehicle. The described method may therefore be simpler than other methods for ascertaining vehicle trajectories. As a result, the described method can be faster than other methods for ascertaining vehicle trajectories. In addition, B-splines may be locally supporting. The optimization of the adjustable steering angle of the vehicle may thus be locally solvable. For example, a solution may first be found in the near region. A solution for smaller times may be found to start with. The adjustable steering angle may first be calculated for small times. A solution may then successively be found for larger distances. Subsequently, a solution may successively be found for greater times, and the adjustable steering angle is then able to be successively calculated for greater times. The solution space of the optimization problem is structured in this way and therefore allows for a solution featuring linear complexity. The ascertained at least two vehicle-setpoint trajectories may be consistent in terms of time.

In a further specific embodiment of the present invention, it is provided that in the ascertainment of the at least two vehicle-setpoint trajectories, the adjustable vehicle parameter of the vehicle taken into account is the adjustable speed of the vehicle.

The advantage of this specific embodiment is that actually realizable speeds of the vehicle, in particular, are able to be considered when ascertaining the at least two vehicle-setpoint trajectories.

In a further specific embodiment of the present invention, it is provided that the adjustable speed of the vehicle is calculated with the aid of a B-spline as a function of time for the ascertainment of each of the at least two vehicle-setpoint trajectories.

The adjustable speed of the vehicle may be an adjustable vehicle parameter that is to be optimized. The adjustable speed of the vehicle v(t) is able to be calculated using a previously defined basis functions (Bᵢ(t):

$$v ( t ) = {\sum }_{i = 0}^{n - 1} {v}_{i} \cdot {B}_{i} ( t )$$

Vᵢ are the parameters to be optimized, with i=(0, . . . , n−1). The instantaneous speed of the vehicle may be utilized as initial condition v₀. Parameters vᵢ are suitably selected for each vehicle-setpoint trajectory. Given predefined parameters vᵢ, the adjustable speed of the vehicle is able to be calculated as a function of time with the aid of the predefined basis functions.

The calculated adjustable speed of the vehicle as a function of time is able to be utilized when ascertaining at least two vehicle-setpoint trajectories. The ascertainment of each of the at least two vehicle-setpoint trajectories may be carried out with the aid of a non-holonomic vehicle model. Based on the calculated adjustable speed of the vehicle as a function of time, and based on an adjustable steering angle as a function of time, the x-y positions and orientations of the vehicle along the at least two vehicle-setpoint trajectories are able to be ascertained in an x,y coordinate system with the aid of the non-holonomic vehicle model.

The advantage of this specific embodiment is that during the ascertainment of each of the at least two vehicle-setpoint trajectories, fewer data are required for the adjustable vehicle parameter of the vehicle than in other methods for ascertaining vehicle trajectories. When ascertaining each of the at least two vehicle-setpoint trajectories, fewer data have to be ascertained for the adjustable speed of the vehicle. The described method may thus be simpler than other methods for ascertaining vehicle trajectories. The described method may therefore be faster than other methods for ascertaining vehicle trajectories. In addition, B-splines may be locally supportive. The optimization of the adjustable speed of the vehicle may thus be locally solvable. For example, a solution in the near region may first be found. At first, a solution for small times may be found. Initially, the adjustable speed is able to be calculated for small times. Then, a solution may successively be found for the far region, whereupon a solution for greater times may successively be determined. Subsequently, the adjustable speed may successively be calculated for greater times. The solution space of the optimization space is structured in this way, and a solution with linear complexity is possible. The ascertained at least two vehicle-setpoint trajectories may be consistent in terms of time.

In a further specific embodiment of the present invention, it is provided that the assessment of the at least two ascertained vehicle-setpoint trajectories is furthermore a function of a predefined assessment measure.

The predefined assessment measure may have a cost function. The assessment of the at least two ascertained vehicle trajectories may be dependent on a cost function in each case. If a vehicle trajectory is to be controlled to one of the at least two ascertained vehicle-setpoint trajectories, then what is known as costs may arise. The lower the costs for a vehicle-setpoint trajectory, the more this vehicle-setpoint trajectory may be preferred in the assessment. The lower the costs for a vehicle-setpoint trajectory, the more this vehicle-setpoint trajectory may be preferred when selecting a vehicle-setpoint trajectory. For example, if at least one static and/or dynamic object that is detected in the environment is located on an ascertained vehicle-setpoint trajectory, this may result in higher costs for this ascertained vehicle-setpoint trajectory. Lower costs may arise for easily realizable steering angles of the vehicle than for steering angles of the vehicles that are more difficult to realize. Easily realizable speeds of the vehicle may entail lower costs than speeds of the vehicle that are more difficult to realize. Also, different altitude profiles along the at least two ascertained vehicle-setpoint trajectories may cause different costs for each of the at least two ascertained vehicle trajectories.

The predefined assessment measure may include a quality measure in addition and/or as an alternative to the cost function. The assessment of the at least two ascertained vehicle-setpoint trajectories may be dependent upon the quality measure in each case. The higher the quality measure for a vehicle-setpoint trajectory, the more this vehicle-setpoint trajectory may be preferred in the assessment. The greater the quality measure for a vehicle-setpoint trajectory, the more this vehicle-setpoint trajectory may be preferred when selecting a vehicle-setpoint trajectory. For example, vehicle-setpoint trajectories that extend parallel to lane demarcations are able to be assessed by a higher quality measure. Vehicle-setpoint trajectories that follow a vehicle traveling ahead, which exhibits a comparable speed and does not change lanes may also be assessed by a higher quality measure.

The advantage of this specific embodiment is that the vehicle-setpoint trajectories are able to be assessed with regard to their realizability. It is possible to select a vehicle-setpoint trajectory that is realizable. It allows for the selection of a vehicle-setpoint trajectory that the vehicle is thematically able to carry out based on the current system status of the vehicle. A vehicle-setpoint trajectory is selectable that is centered between the lane demarcations to the greatest extent possible. A vehicle-setpoint trajectory devoid of collisions with detected objects, especially with regard to detected static objects, is able to be selected.

In a further specific embodiment of the present invention, it is provided that the assessment of the at least two ascertained vehicle-setpoint trajectories takes place with the aid of a neural network, in particular with the aid of a convolutional neural network.

The advantage of this specific embodiment is that such networks are able to be trained by methods of machine learning so that even complex scenarios involving a very high number of objects are able to be efficiently managed.

In a further specific embodiment of the present invention, it is provided that the step of ascertaining the at least two vehicle-setpoint trajectories and the step of assessing the at least two ascertained vehicle-setpoint trajectories are carried out in a coupled manner.

The coupled sequence is possible because the optimization of at least one adjustable vehicle parameter of the vehicle may be locally solvable. The advantage of this specific development is that the vehicle-setpoint trajectories are able to be set up in an iterative manner in the far distance based on the current position of the vehicle. The vehicle-setpoint trajectories may be iteratively set up for greater times based on the current point in time. Considerably fewer vehicle-setpoint trajectories will then have to be ascertained and assessed as a whole across the extension of the entire vehicle-setpoint trajectory.

In a further specific embodiment of the present invention, it is provided that in the step of controlling an adjustable vehicle parameter as a function of the selected vehicle-setpoint trajectory, the adjustable vehicle parameter is an adjustable steering angle of the vehicle and/or an adjustable speed of the vehicle.

The advantage of this specific embodiment is that the described method is able to be used for operating an autonomous vehicle.

In a further specific embodiment of the present invention, it is provided that the method includes the following additional step: ascertaining a driving corridor as a function of the selected vehicle-setpoint trajectory; and that in the step of controlling an adjustable vehicle parameter, the adjustable vehicle parameter is an adjustable steering-wheel torque, which is controlled in such a way that the vehicle moves along the ascertained driving corridor. The vehicle particularly moves inside the ascertained driving corridor.

In this context, the driving corridor is defined by the vehicle position along a vehicle trajectory and at least by the width of the vehicle. Furthermore, objects that were detected in the environment of the vehicle may be detected as lateral delimitations of the driving corridor. Such objects, for example, could be lane markings or parked vehicles.

The advantage of this specific embodiment is that the described method is able to be used for operating a vehicle that is equipped with a driver-assistance system, in particular a steering-assistance system. The described method may be used in a lane-keeping assistant. For example, based on the selected vehicle-setpoint trajectory, at least one lane demarcation is able to be detected based on the selected vehicle-setpoint trajectory. The adjustable steering-wheel torque is able to be controlled in such a way that based on the selected vehicle-setpoint trajectory, the vehicle does not cross the at least one detected lane demarcation. As long as the driver keeps the vehicle next to the at least one lane demarcation, no steering-wheel torque is applied by the system. Driving on a side delimitation of the driving corridor is able to be avoided, and it is possible to avoid driving over a side delimitation of the driving corridor.

In a further specific embodiment of the present invention, it is provided that the method includes the additional step of reading in additional informational data. Furthermore, at least one item of the additional informational data is taken into consideration in the detection of at least one object in an environment of the vehicle and/or also in the ascertainment of at least two vehicle-setpoint trajectories and/or also in the assessment of the at least two ascertained vehicle-setpoint trajectories.

Additional informational data, for example, may be data from additional environmental sensors, which are installed on and/or in the vehicle, in addition to the vehicle camera. Additional informational data, for example, can be information from geographical maps. Additional informational data may be information from the situation analysis of an autonomous vehicle. Additional informational data may be information from the situation analysis of a vehicle that includes a driver-assistance system. Information from the situation analysis, for instance, may be information relating to the detection of movements of dynamic objects in the environment of the vehicle. Additional information may be information from an action planner of an autonomous vehicle. Additional information can be information from an action planner of a vehicle.

The present invention also pertains to a computer program product having product code for executing the afore-described method. The computer program product is able to be used for executing the method according to one of the afore-described specific embodiments when the program product is executed on a computer or a device. The program code may be stored on a machine-readable carrier such as a semiconductor memory, a hard disk memory or an optical memory.

The described method, for example, may be implemented in software or in hardware or in a mixed form of software and hardware, e.g., in a control unit. The described method may be implemented on a central control unit of the vehicle, for example. The described method may be implemented in a control unit of the vehicle camera, for instance.

In addition, the present invention is based on a device for operating a vehicle. The device includes at least one vehicle-parameter read-in device for reading in at least one adjustable vehicle parameter and at least one fixed vehicle parameter; furthermore, it includes at least one vehicle-camera data read-in device for reading in vehicle-camera data; and moreover, at least one detection device for detecting at least one object in an environment of the vehicle with the aid of the vehicle-camera data read-in device.

According to the present invention, the device furthermore includes at least one trajectory-ascertainment device for ascertaining at least two vehicle-setpoint trajectories, each taking into account at least one adjustable vehicle parameter of the vehicle and at least one fixed vehicle parameter of the vehicle; at least one assessment device for assessing the at least two ascertained vehicle-setpoint trajectories as a function of the at least one detected object; at least one selection device for selecting a vehicle-setpoint trajectory as a function of the assessment; and at least one control device for controlling at least one adjustable vehicle parameter as a function of the selected vehicle-setpoint trajectory.

### BRIEF DESCRIPTION OF THE DRAWINGS

FIG. 1 shows a device for operating a vehicle according to the present invention.

FIG. 2 shows a method for operating a vehicle according to the present invention.

FIG. 3 shows a four vehicle-setpoint trajectories ascertained using the method according to the present invention.

FIG. 4 shows a vehicle-setpoint trajectory, selected according to the method of the present invention, in the environment of the vehicle.

### DETAILED DESCRIPTION

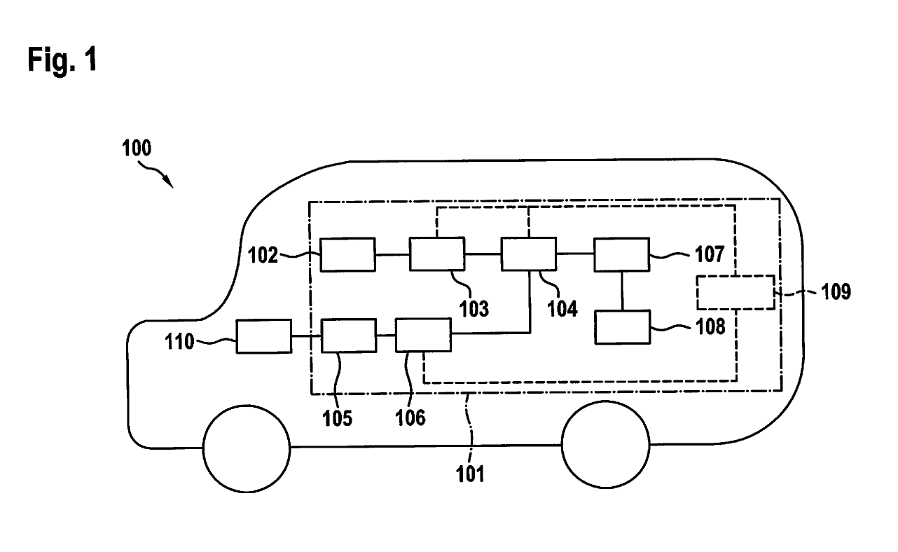

FIG. 1 shows vehicle 100 having device 101 for operating vehicle 100. Device 101 has vehicle-camera data read-in device 105. With the aid of vehicle-camera data read-in device 105, vehicle-camera data that were recorded using vehicle camera 110 of vehicle 100 are able to be read in. Device 101 furthermore includes detection device 106 for detecting at least one object in an environment of the vehicle. The detection of at least one object takes place on the basis of the read-in vehicle-camera data. For this purpose, the vehicle-camera data are transmitted to detection device 106 in the form of a signal that represents the vehicle-camera data. Detection device 106, for instance, is able to detect static objects such as lane demarcations, components of the vegetation in the environment of vehicle 100, a parked vehicle and/or a building in the environment of vehicle 100. Detection device 106 is also able to detect dynamic objects such as a driving vehicle and/or a further road user, for example. The information about a detected object may be transmitted to assessment device 104 of device 101 in the form of a signal that represents the detected object.

In addition, device 101 has vehicle-parameter read-in device 102. With the aid of vehicle-parameter read-in device 102, at least one adjustable vehicle parameter and at least one fixed vehicle parameter of vehicle 100 are able to be read in. Vehicle parameter read-in device 102, for example, may read in the adjustable speed and/or the adjustable steering angle of vehicle 100. For instance, vehicle parameter read-in device 102 may read in the wheel base, the length, the width, the maximum speed, the maximum acceleration and/or the maximum steering angle of vehicle 100. The read-in vehicle parameters are transmitted to trajectory-ascertainment device 103 of device 101 in the form of at least one signal, which represents the read-in vehicle parameters.

With the aid of trajectory-ascertainment device 103, at least two vehicle-setpoint trajectories are ascertained in each case. At least one adjustable vehicle parameter of vehicle 100 and one fixed vehicle parameter of vehicle 100 are considered in each case. The considered adjustable vehicle parameter of vehicle 100 may be the adjustable steering angle of vehicle 100. For the ascertainment of each of the at least two vehicle-setpoint trajectories, the adjustable steering angle 40 of vehicle 100 is able to be calculated with the aid of a B-spline as a function of time t:

$$δ ( t ) = {\sum }_{i = 0}^{n - 1} {δ}_{i} \cdot {B}_{i} ( t )$$

Here, Bᵢ(t) are the predefined basis functions, and δᵢ is the parameter to be optimized, with i=(0, . . . , n−1).

The considered adjustable vehicle parameter of vehicle 100 may alternatively or additionally be the adjustable speed of vehicle 100. To ascertain each of the at least two vehicle-setpoint trajectories, the adjustable speed v(t) of vehicle 100 is able to be calculated with the aid of a B-spline as a function of time t:

$$v ( t ) = {\sum }_{i = 0}^{n - 1} {v}_{i} \cdot {B}_{i} ( t )$$

Here, Bᵢ(t) are the predefined basis functions, and vᵢ is the parameter to be optimized, with i=(0, . . . , n−1).

Then, trajectory-ascertainment device 103 is able to ascertain the at least two vehicle-setpoint trajectories with the aid of a non-holonomic vehicle model based on a calculated V adjustable steering angle of vehicle 100 as a function of time and based on an adjustable speed of vehicle 100 as a function of time. In so doing, trajectory-ascertainment device 103 ascertains the x- and y-positions and the orientations along the at least two vehicle-setpoint trajectories in an x,y coordinate system. The information about the ascertained at least two vehicle-setpoint trajectories is transmitted to assessment device 104 of device 101 in the form of at least one signal that represents the information about the ascertained at least two vehicle-setpoint trajectories.

Assessment device 104 thus has at its disposal at least one item of information about an object detected in the environment of vehicle 100 and at least one item of information about the ascertained at least two vehicle-setpoint trajectories. Depending on the at least one detected object, assessment device 104 assesses the at least two ascertained vehicle-setpoint trajectories. The assessment with the aid of assessment device 104 may be dependent on a predefined assessment measure. The assessment measure may have a cost function and/or a quality measure. Assessment device 104 may be developed in such a way that the assessment is performed with the aid of a neural network. Assessment device 104 may be developed so that the assessment is carried out with the aid of a convolutional neural network. The information about the assessed at least two vehicle-setpoint trajectories is transmitted to selection device 107 of device 101 in the form of at least one signal that represents the information about the assessed at least two vehicle-setpoint trajectories.

Using selection device 107, a vehicle-setpoint trajectory is selected as a function of the assessment. The x- and y-positions and the orientations along the selected vehicle-setpoint trajectory are forwarded to control unit 108 of the device in the form of at least one signal, which represents the x- and y-positions and the orientations along the at least two vehicle-setpoint trajectories in an x,y coordinate system of the selected vehicle-setpoint trajectory.

Control unit 108 controls at least one adjustable vehicle parameter of vehicle 100 as a function of the selected vehicle-setpoint trajectory. If vehicle 100 is an autonomously driving vehicle, then the adjustable vehicle parameter of vehicle 100 to be controlled by control unit 108 may be an adjustable steering angle of vehicle 100 and/or an adjustable speed of vehicle 100. If vehicle 100 includes a driver-assistance system, in particular a steering-assistance system, then the adjustable vehicle parameter of vehicle 100 to be controlled by control unit 108 may be an adjustable steering-wheel torque of vehicle 100.

Device 101 of vehicle 100 may optionally include an interface 109 for reading in additional information. The read-in additional information is able to be transmitted from interface 109 in the form of at least one signal, which represents the additional information, to trajectory-ascertainment device 103, assessment device 104 and/or detection device 106. The additional information may be taken into consideration by trajectory-ascertainment device 103, assessment device 104 and/or detection device 106.

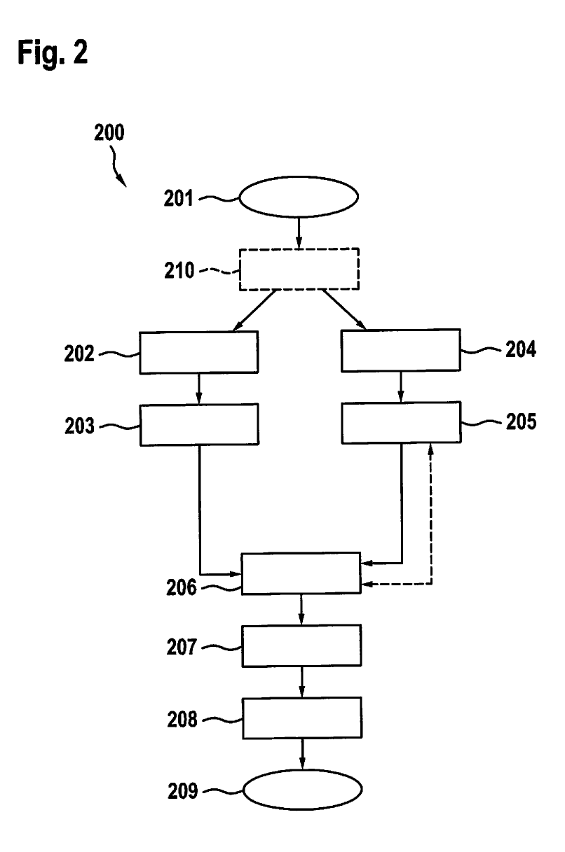

FIG. 2 shows the method according to the present invention for operating a vehicle. The method starts in step 201. In step 202, vehicle-camera data from a vehicle camera are read in. Based on the read-in vehicle-camera data, at least one object is detected in the environment of the vehicle in step 203. Parallel with step 202, at least one adjustable vehicle parameter of the vehicle and at least one fixed vehicle parameter of the vehicle are read in in step 204. The at least one adjustable vehicle parameter and the at least one fixed vehicle parameter of the vehicle are taken into account in step 205, in which at least two vehicle-setpoint trajectories are ascertained. An adjustable vehicle parameter of the vehicle considered in ascertainment 205 may particularly be the adjustable steering angle of the vehicle. For ascertainment 205 of each of the at least two vehicle-setpoint trajectories, the adjustable steering angle of the vehicle, in particular, is calculated with the aid of a B-spline as a function of time. Additionally or alternatively, an adjustable vehicle parameter of the vehicle considered in ascertainment 205 in particular may be the adjustable speed of the vehicle. For ascertainment 205 of each of the at least two vehicle-setpoint trajectories, the adjustable speed of the vehicle, in particular, is calculated with the aid of a B-spline as a function of time.

Based on the at least one object in the environment of the vehicle detected in step 203, and based on the at least two vehicle-setpoint trajectories ascertained in step 205, the at least two vehicle-setpoint trajectories are assessed in step 206. The assessment in step 206 in particular is a function of a predefined assessment measure. The assessment measure may have a cost function and/or a quality measure. The assessment in step 206 is able to be carried out with the aid of a neural network. The assessment in step 206 may be carried out with the aid of a convolutional neural network.

Depending on the assessment in step 206, a vehicle-setpoint trajectory is selected in step 207.

In step 208, at least one adjustable vehicle parameter of the vehicle is controlled as a function of the selected vehicle-setpoint trajectory. In one specific embodiment, the adjustable vehicle parameter can be an adjustable steering angle of the vehicle and/or an adjustable speed of the vehicle. The control according to this specific embodiment may especially take place when the vehicle is an autonomously driving vehicle. In another specific embodiment, the adjustable vehicle parameter may be an adjustable steering-wheel torque. The control according to this specific embodiment may particularly take place when the vehicle is equipped with a driver-assistance system.

The present method ends in step 209.

In optional step 210, additional informational data may be read in. The read-in additional informational data are able to be taken into account in the detection of at least one object in the environment of the vehicle according to step 203, in the ascertainment of at least two vehicle-setpoint trajectories according to step 205, and/or in the assessment of the at least two ascertained vehicle-setpoint trajectories according to step 206.

Optionally, the ascertainment of the at least two vehicle-setpoint trajectories according to step 205 and the assessment of the at least two ascertained vehicle-setpoint trajectories according to step 206 are able to be carried out in a coupled manner. This is represented by the duplicate case which links the two steps with each other. The coupled sequence, for example, may be realized in such a way that during the ascertainment of the at least two vehicle-setpoint trajectories, the adjustable steering angle of the vehicle is calculated as a function of time and/or the adjustable speed of the vehicle is calculated as a function of the time initially in the near region with the aid of a B-spline. Initially, the calculation is carried out for small times. The results ascertained in the calculation are able to be directly assessed in step 206. Depending on this assessment, the calculation of the adjustable steering angle of the vehicle then takes place as a function of time, and/or the calculation of the adjustable speed of the vehicle is carried out as a function of time for the far region. The calculation for larger times thus takes place only subsequent to a first assessment according to step 206.

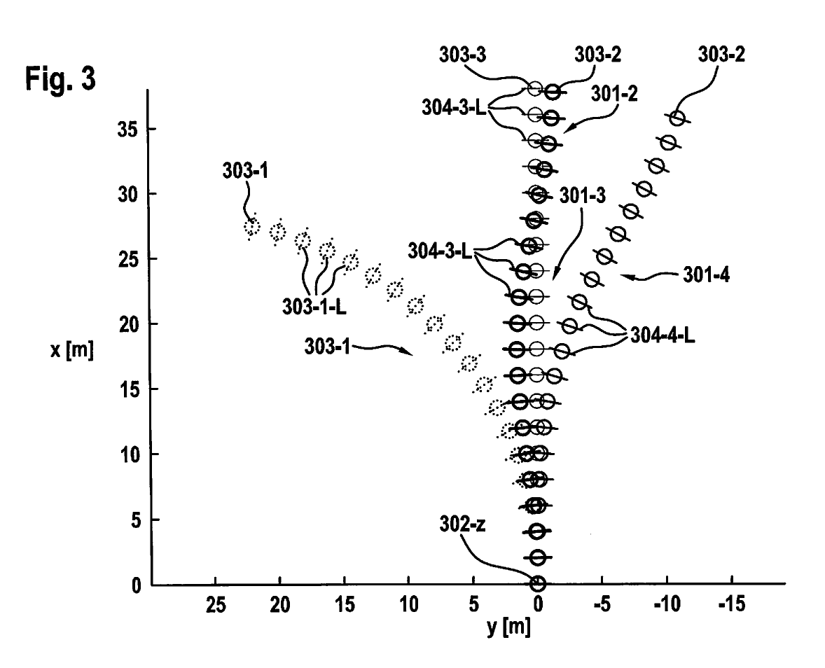

FIG. 3 shows the four vehicle-setpoint trajectories 301-1, 301-2, 301-3 and 301-4, which were ascertained using method 200 in step 205. Vehicle-setpoint trajectories 301-1, 301-2, 301-3 and 301-4 are shown in an x-y coordinate system. They were calculated starting from respective starting points 302-1, 302-2, 302-3 and 302-4 to respective end points 303-1, 303-2, 303-3 and 303-4 of each vehicle-setpoint trajectory 301-1, 301-2, 301-3 and 301-4 in each case. Furthermore, a plurality of curve points 304-1-L, 304-2-L, 304-3-L and 304-4-L is shown for each of calculated vehicle-setpoint trajectories 301-1, 301-2, 301-3 and 301-4. B-splines were used when ascertaining each of vehicle-setpoint trajectories 301-1, 301-2, 301-3 and 301-4. B-splines of grade 1 with three control points were utilized.

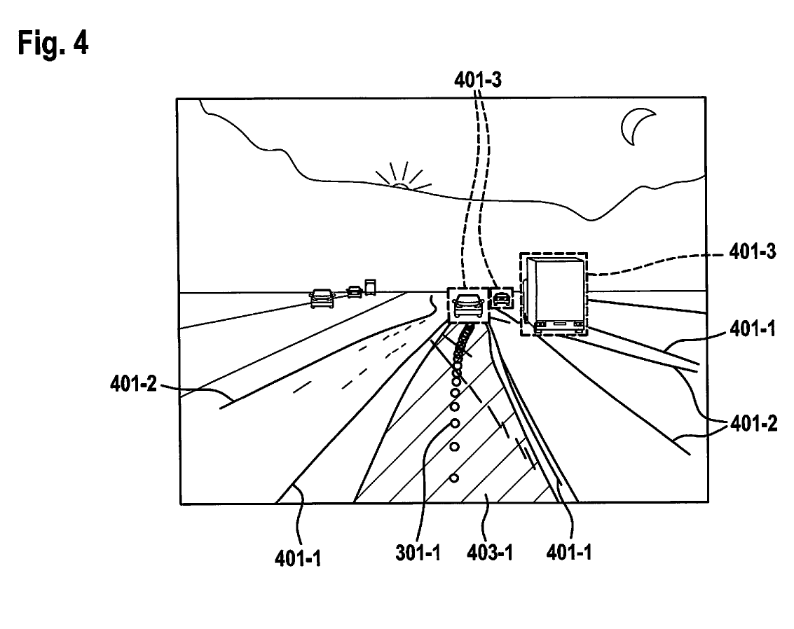

FIG. 4 shows an image of the environment of a vehicle, which could have been recorded by a vehicle camera in the front region of the vehicle, for example. Marked are objects 401-1, 401-2 and 401-3, which were detected in the environment of the vehicle with the aid of the read-in vehicle-camera data. The objects marked by 401-1 are yellow lane demarcations. The objects marked by 401-2 are white lane demarcations. The objects marked by 401-3 are other vehicles that are moving in the same driving direction as the vehicle from where the image was recorded. According to step 205 of the afore-described method 200, at least two vehicle-setpoint trajectories 301-z were ascertained with the aid of a device 101 of the vehicle. Here, index z is representative of a number from 1 to z and characterizes the at least two vehicle-setpoint trajectories ascertained according to step 205 of method 200 in each case. For example, as illustrated in FIG. 3, four vehicle-setpoint trajectories 301-1, 301-2, 301-3 and 301-4 may have been ascertained. According to step 206 of the afore-described method 200, the at least two vehicle-setpoint trajectories 301-z were assessed and one of the at least two vehicle-setpoint trajectories was selected as a function of the assessment. In the example, vehicle-setpoint trajectory 301-1 was selected. Area 403-1 marks the vehicle-setpoint corridor associated with vehicle-setpoint trajectory 301-1. In this instance, the assessment was dependent upon an assessment measure which had a cost function, for example. In the example, the cost function was developed in such a way that preference was given to vehicle-setpoint trajectory 301-1 that optimally lies inside the yellow lane demarcations and is free of collisions with regard to the static objects. In addition, the positions and speeds of the detected vehicles 401-3 may have been taken into account in the assessment of vehicle-setpoint trajectories 301-z.

What is claimed is:

1. A method for operating a vehicle, comprising:
reading in at least one adjustable vehicle parameter and at least one fixed vehicle parameter;
reading in vehicle-camera data;
detecting at least one object in an environment of the vehicle with the aid of the read in vehicle-camera data;
ascertaining at least two vehicle-setpoint trajectories, taking into account at least one adjustable vehicle parameter and at least one fixed vehicle parameter of the vehicle in each case;
assessing the at least two ascertained vehicle-setpoint trajectories as a function of the at least one detected object;
selecting a vehicle-setpoint trajectory as a function of the assessing; and
controlling at least one adjustable vehicle parameter as a function of the selected vehicle-setpoint trajectory.

2. The method as recited in claim 1, wherein the adjustable vehicle parameter of the vehicle taken into account in the ascertaining of the at least two vehicle-setpoint trajectories is an adjustable steering angle of the vehicle (100).

3. The method as recited in claim 2, wherein for the ascertaining of each of the at least two vehicle-setpoint trajectories, the adjustable steering angle of the vehicle is calculated with the aid of a B-spline as a function of time.

4. The method as recited in claim 1, wherein the adjustable vehicle parameter of the vehicle taken into account in the ascertaining of the at least two vehicle-setpoint trajectories is an adjustable speed of the vehicle.

5. The method as recited in claim 4, wherein for the ascertaining of each of the at least two vehicle-setpoint trajectories, the adjustable speed of the vehicle is calculated with the aid of a B-spline as a function of time.

6. The method as recited in claim 1, wherein the assessing of the at least two ascertained vehicle-setpoint trajectories is performed a function of a predefined assessment measure.

7. The method as recited in claim 1, wherein the assessing of the at least two ascertained vehicle-setpoint trajectories takes place with the aid of a neural network.

8. The method as recited in claim 7, wherein the neural network is a convolutional neural network.

9. The method as recited in claim 1, wherein the step of ascertaining the at least two vehicle-setpoint trajectories and the step of assessing the at least two ascertained vehicle-setpoint trajectories are carried out in a coupled manner.

10. The method as recited in claim 1, wherein in the step of controlling the adjustable vehicle parameter as a function of the selected vehicle-setpoint trajectory, the adjustable vehicle parameter is at least one of an adjustable steering angle of the vehicle and an adjustable speed of vehicle.

11. The method as recited in claim 1, further comprising:
ascertaining a driving corridor as a function of the selected vehicle-setpoint trajectory; and
in the step of controlling the adjustable vehicle parameter, the adjustable vehicle parameter is an adjustable steering-wheel torque that is controlled in such a way that the vehicle moves along the ascertained driving corridor.

12. The method as recited in claim 1, further comprising:
reading in additional informational data and taking into account at least one of the additional items of informational data in at least one of the following:
in the detecting of the at least one object in the environment of the vehicle,
in the ascertaining of the at least two vehicle-setpoint trajectories, and
in the assessing of the at least two ascertained vehicle-setpoint trajectories.

13. A computer-program product having program code for executing a method for operating a vehicle, the method comprising:
reading in at least one adjustable vehicle parameter and at least one fixed vehicle parameter;
reading in vehicle-camera data;
detecting at least one object in an environment of the vehicle with the aid of the read in vehicle-camera data;
ascertaining at least two vehicle-setpoint trajectories, taking into account at least one adjustable vehicle parameter and at least one fixed vehicle parameter of the vehicle in each case;
assessing the at least two ascertained vehicle-setpoint trajectories as a function of the at least one detected object;
selecting a vehicle-setpoint trajectory as a function of the assessing; and
controlling at least one adjustable vehicle parameter as a function of the selected vehicle-setpoint trajectory.

14. A device for operating a vehicle, comprising:
at least one vehicle parameter read-in device for reading in at least one adjustable vehicle parameter and at least one fixed vehicle parameter;
at least one vehicle camera data read-in device for reading in vehicle-camera data;
at least one detection device for detecting at least one object in an environment of the vehicle on the basis of the read-in vehicle-camera data;
at least one trajectory-ascertainment device for ascertaining at least two vehicle-setpoint trajectories the at least one trajectory-ascertainment device taking into account at least one adjustable vehicle parameter of the vehicle and at least one fixed vehicle parameter of the vehicle in each case;
at least one assessment device for assessing the at least two ascertained vehicle-setpoint trajectories as a function of the at least one detected object;
at least one selection device for selecting a vehicle-setpoint trajectory as a function of the assessment; and
at least one control unit for controlling at least one adjustable vehicle parameter as a function of the selected vehicle-setpoint trajectory.
